(19) United States
(12) Patent Application Publication
(10) Pub. No.: US 2022/0180400 A1
(43) Pub. Date: Jun. 9, 2022

(54) INFORMATION PROCESSING APPARATUS, DISPLAY SYSTEM, AND INFORMATION PROCESSING METHOD

(71) Applicant: NEC Corporation, Minato-ku, Tokyo (JP)

(72) Inventors: Masamichi TANABE, Tokyo (JP); Yuusuke KAYANO, Tokyo (JP); Jun UCHIMURA, Tokyo (JP); Toshikazu NAKAJIMA, Tokyo (JP); Tomoyuki NISHIMURA, Tokyo (JP)

(73) Assignee: NEC Corporation, Minato-ku, Tokyo (JP)

(21) Appl. No.: 17/437,980

(22) PCT Filed: Mar. 3, 2020
(86) PCT No.: PCT/JP2020/008975

§ 371 Date: Sep. 10, 2021

(30) Foreign Application Priority Data
Mar. 25, 2019 (JP) 2019-055882

(51) Int. Cl. G06Q 30/02; G06Q 30/06

(52) U.S. Cl. CPC G06Q 30/0255; G06Q 30/0631; G06Q 30/0641; G06Q 30/0639; G06Q 30/0201

(57) ABSTRACT

An information processing apparatus comprises: an acquisition unit that acquires information indicating a featured product including a product of interest to a customer visiting a store; and an output unit that outputs ranking information, that satisfies a first criterion, regarding a sales performance of the featured product and regarding a parameter.

### TECHNICAL FIELD

The present disclosure relates to an information processing apparatus, a display system, an information processing method, and a program.

### BACKGROUND ART

To improve the sales of products, it is necessary to increase the customer's willingness to purchase, and as one method thereof, there is a method of showing sales promotion information to the customer. The sales promotion information is generally so-called advertisement for increasing customer's willingness to purchase.

PTL 1 discloses an information providing method for increasing the willingness to purchase of many customers having a wide variety of preferences by providing different types of sales promotion information when providing sales promotion information to customers.

In the above-described information providing method, an image acquired by a camera is analyzed, features such as gender and age of a customer photographed in the image are estimated, and sales promotion information to be presented is specified using the estimated features. A degree of popularity of a product and a sales ranking are displayed as sales promotion information.

### CITATION LIST

### Patent Literature

[PTL 1] JP 2015-88166 A

### SUMMARY OF INVENTION

### Technical Problem

As described above, in PTL 1, the degree of popularity and the sales ranking are displayed as the sales promotion information, but a product of interest to customers is not necessarily a highly popular product or a product ranked high in ranking. There is therefore a problem that it may not be possible to grasp a ranking of the product of interest to the customer.

An object of the present disclosure is to provide an information processing apparatus, a display system, an information processing method, and a recording medium recording a program that solve the above-described problem and enables a customer to easily grasp a ranking of a product of interest.

### Solution to Problem

An information processing apparatus according to an aspect of the present disclosure includes: an acquisition means for acquiring information indicating a featured product including a product of interest to a customer visiting a store; and an output means for outputting ranking information, that satisfies a first criterion, regarding a sales performance of the featured product and regarding a parameter.

A display system according to an aspect of the present disclosure includes: an information processing apparatus including an acquisition means for acquiring information indicating a featured product including a product of interest to a customer visiting a store, and an output means for outputting ranking information, that satisfies a first criterion, regarding a sales performance of the featured product and regarding a parameter; and a display device that is installed in the store and displays the ranking information output by the output means.

An information processing method according to an aspect of the present disclosure includes: acquiring information indicating a featured product including a product of interest to a customer visiting a store; and outputting ranking information, that satisfies a first criterion, regarding a sales performance of the featured product and regarding a parameter.

A recording medium according to an aspect of the present disclosure records a program for causing a computer to execute: a process of acquiring information indicating a featured product including a product of interest to a customer visiting a store; and a process of outputting ranking information, that satisfies a first criterion, regarding a sales performance of the featured product and regarding a parameter.

### Advantageous Effects of Invention

An effect of the present disclosure is to enable a customer to easily grasp a ranking of a product of interest.

### BRIEF DESCRIPTION OF DRAWINGS

FIG. 1 is a block diagram illustrating an example of a configuration of an information processing system according to a first example embodiment.

FIG. 2 is a diagram illustrating an example of a use form of the information processing system according to the first example embodiment.

FIG. 3A is a block diagram illustrating a configuration of an information processing apparatus.

FIG. 3B is a block diagram illustrating a configuration of an output unit.

FIG. 4 is a diagram illustrating an example of sales performance data.

FIG. 5 is a block diagram illustrating examples of functional configuration units of a specifying unit.

FIG. 6 is a flowchart illustrating operation of the specifying unit.

FIG. 7 is a diagram illustrating an example of aggregated data.

FIG. 8 is a diagram illustrating an example of extracted parameter candidates.

FIG. 9 is a diagram illustrating an example of a result of sorting sales performances.

FIG. 10 is a diagram illustrating an example of specific parameter information.

FIG. 11 is a flowchart illustrating operation of the information processing apparatus according to the first example embodiment.

FIG. 12 is a block diagram illustrating an example of a configuration of an image analysis device of the information processing system according to the first example embodiment.

FIG. 13 is a diagram illustrating an example of a screen output to a digital signage.

FIG. 14 is a block diagram illustrating a configuration of an image analysis device of an information processing system according to a second example embodiment.

FIG. 15 is a flowchart illustrating operation of the information processing system according to the second example embodiment.

FIG. 16 is a diagram illustrating another example of the screen output to the digital signage.

FIG. 17 is a diagram illustrating an example of a hardware configuration of the information processing apparatus according to each example embodiment.

### EXAMPLE EMBODIMENT

Example embodiments will be described in detail with reference to the drawings. In the drawings, and the example embodiments described herein, the same reference numerals are given to the same components, and the description thereof will be omitted as appropriate.

### First Example Embodiment

A first example embodiment will be described.

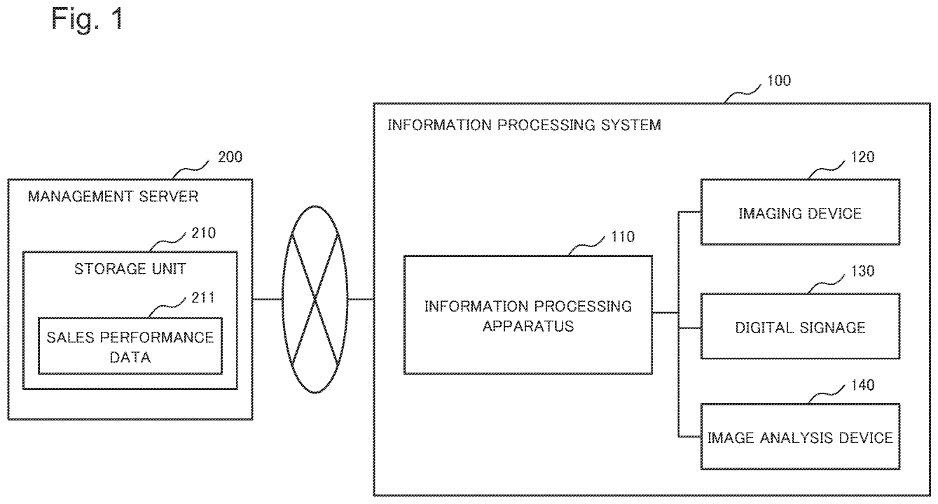

FIG. 1 is a block diagram illustrating an example of a configuration of an information processing system 100 according to the first example embodiment. As illustrated in FIG. 1, the information processing system 100 includes an information processing apparatus 110, an imaging device 120, a digital signage 130, and an image analysis device 140. The imaging device 120 and the digital signage 130 are installed in a store in a retail business, for example, a convenience store, a supermarket, or the like.

The information processing apparatus 110 is, for example, a computer, and performs processes such as control of each device such as the imaging device 120, the digital signage 130, or the image analysis device 140, acquisition of information from each device, and analysis of the acquired information.

The information processing system 100 is also communicably connected to a management server 200. The management server 200 is, for example, a computer, and performs product management, sales management, and the like in the store. Not limited to the product management and sales management in the store, the management server 200 may perform product management and sales management in other stores. The management server 200 may be installed in a store, or may be disposed in a place different from the store and connected to the information processing system 100 via a communication network. That is, the management server 200 may be implemented by a cloud computing system.

The imaging device 120 is, for example, a camera or a video camera installed in various places such as a ceiling, a wall surface, and a product shelf of a store. The imaging device 120 may also be built in or externally attached to the digital signage 130, for example. The imaging device 120 notifies the image analysis device 140 of generated imaged data. The imaged data of which the image analysis device 140 is notified and that is a moving image or a still image may be stored in a storage unit (not illustrated).

The digital signage 130 is a device that displays advertisement content such as video and characters by a display, a projector, or the like. The digital signage 130 includes a display device such as a liquid crystal display, an organic light emitting diode (OLED) display, or a light emitting diode (LED) display. The advertisement content displayed on the digital signage 130 may be a moving image, or may be a still image. The digital signage 130 outputs advertisement content from the information processing apparatus 110 to a display or the like on the basis of an instruction from the information processing apparatus 110. In the present example embodiment, the advertisement content includes ranking information described later. The digital signage 130 is only required to be a device including a function capable of communicating with at least an output device, an input device, and the information processing apparatus 110, and is not limited to a digital signage. The digital signage 130 may be configured integrally with the information processing apparatus 110.

An installation location of the digital signage 130 is not particularly limited. For example, the digital signage 130 may be installed on a product shelf, on a door of the product shelf, or in the vicinity of the product shelf, in the store.

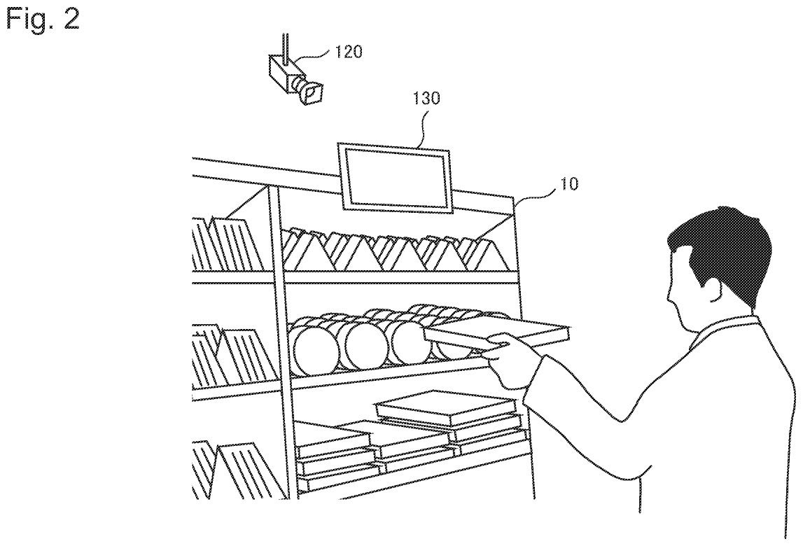

FIG. 2 is a diagram illustrating an example of a use form of the information processing system 100 according to the first example embodiment. As illustrated in FIG. 2, for example, the imaging device 120 is installed on a ceiling above a product shelf 10 in a store. The digital signage 130 is installed on the product shelf 10, for example. The imaging device 120 is installed to be able to image at least a customer near the product shelf 10 on which the digital signage 130 is installed. A plurality of the imaging devices 120 may be installed in the store, and each may be communicably connected to the information processing apparatus 110 and the image analysis device 140. A plurality of the digital signages 130 may be installed in the store, and each may be communicably connected to the information processing apparatus 110. The digital signage 130 and the information processing apparatus 110 may constitute a display system.

The information processing system 100 can be used not only in normal stores but also in labor-saving stores and unmanned stores. The labor-saving store or the unmanned store is a small store in which, for the purpose of improving operation efficiency and expanding to a small trading area, a computer system reduces work of a store clerk regarding registration and settlement of a purchased product, customer service support, in-store monitoring, inventory management, facility management, and the like, and reduces the number of resident store clerks to less than that of normal stores, or to zero.

The information processing system 100 can also be used in a mother store that manages a labor-saving store or an unmanned store, the labor-saving store, or the unmanned store (child store). For example, the imaging device 120 and the digital signage 130 may be installed in the child store, and may be connected to the information processing apparatus 110 installed in the mother store via a communication network. Some of functional configuration units of the information processing apparatus 110 may be installed in the child store. Arrangement of the information processing system 100 is not limited to these.

<Functional Configuration of Information Processing Apparatus 110>

Each functional configuration unit of the information processing apparatus 110 will be described.

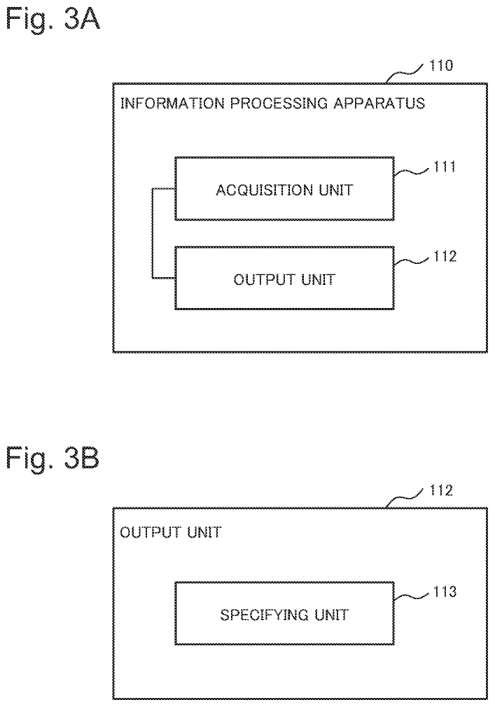

FIG. 3A is a block diagram illustrating a configuration of the information processing apparatus 110 illustrated in FIG. 1. As illustrated in FIG. 3A, the information processing apparatus 110 includes an acquisition unit 111 and an output unit 112.

The acquisition unit 111 acquires information indicating a featured product including a product of interest to a customer visiting a store. The product of interest to the customer is a product that the customer shows an interest in, and is, for example, a product detected to be picked up by the customer, but is not limited thereto. The product of interest to the customer visiting the store is also referred to as a “featured product”. The information indicating the featured product is also referred to as “featured product information”. The featured product information may be a product name of a product. The featured product may include a product related to the product of interest to the customer. The acquisition unit 111 acquires the featured product information from the image analysis device 140, for example. The acquisition unit 111 corresponds to an acquisition means that acquires the information indicating the featured product including the product of interest to the customer visiting the store.

The output unit 112 outputs ranking information, that satisfies a first criterion, regarding a sales performance of the featured product and regarding a parameter. The output unit 112 corresponds to an output means that outputs the ranking information, that satisfies a first criterion, regarding the sales performance of the featured product and regarding the parameter.

FIG. 3B is a block diagram illustrating a configuration of the output unit 112. The output unit 112 includes a specifying unit 113. The specifying unit 113 specifies a parameter with which the ranking information regarding the sales performance of the featured product satisfies the first criterion, on the basis of the sales performance data associated with the parameter regarding the sales performance of each of the plurality of sales products including the featured product. The output unit 112 outputs ranking information regarding the parameter specified by the specifying unit 113.

The ranking information is calculated on the basis of the sales performance data of each of the plurality of sales products including the featured product.

<Sales Performance Data 211>

The information processing apparatus 110 is communicably connected to the management server 200. Sales performance data 211 is stored in a storage unit 210 of the management server 200.

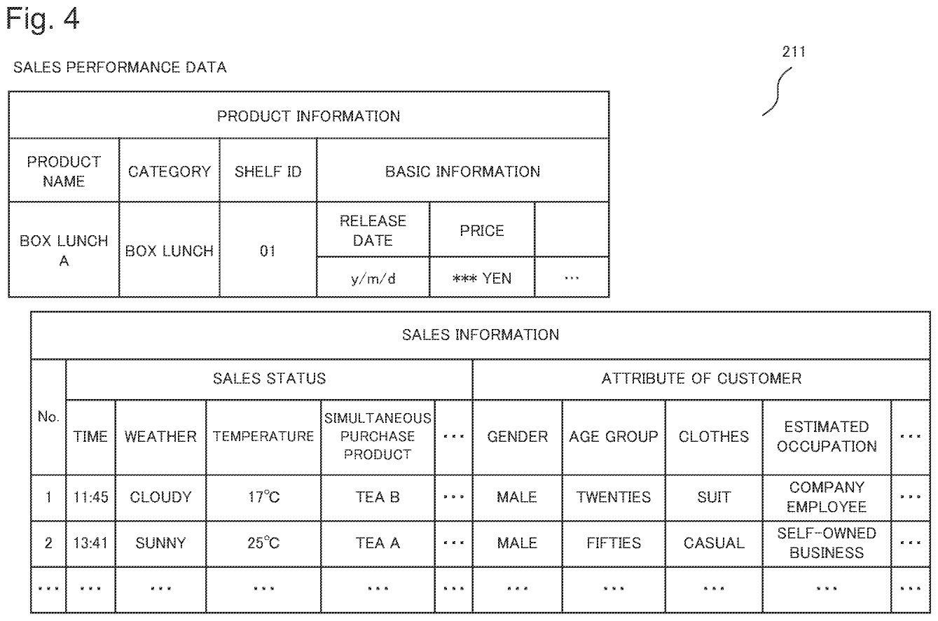

FIG. 4 is a diagram illustrating an example of the sales performance data 211. The sales performance data 211 is data in which product information and sales information are associated with each other. The product information is information regarding a sales product, and includes, for example, a product name, a category, a shelf identification (ID), and basic information. The basic information includes, for example, a release date and a price of the product. The product name may be, for example, a brand of the product.

The sales information is information regarding sales of the product associated. FIG. 4 illustrates that product information of a product name (brand) of “box lunch A” is associated with sales information of, for example, “No. 1” “No. 2”. The sales information includes, for example, a sales status and an attribute of a customer. The sales status includes, for example, time when the product is sold, weather, temperature, and a simultaneous purchase product. The attribute of the customer includes, for example, a gender, an age group, clothes, and an estimated occupation. The attribute of the customer may include member information, a means of visiting the store, and the like. The items of the sales status and the attribute of the customer are not limited to the above. Here, each item of the information regarding the sales performance of the product is referred to as a “parameter”. The parameter may be set in advance.

It is sufficient that the parameter is set in a point of sale (POS) system in advance. For example, the POS system acquires values (for example, “11: 45” and “cloudy” that are values of time and weather) of parameters at the time of product registration, and generates and stores sales performance data including the acquired values. The value of the parameter may be not only an actually acquired value but also a value estimated by the POS system. The sales performance data generated by the POS system in the store may be transmitted to the management server 200 each time the sales performance data is generated, or may be collectively transmitted to the management server 200 at a predetermined timing.

FIG. 4 illustrates the sales performance data of “box lunch A”, and the sales performance data of all the sales products in the store may be generated and stored in the management server 200. The sales performance data may be sales performance data of some sales products in the store. The sales performance data may be data indicating all sales performance in the past, or may be data indicating sales performance in a predetermined period (for example, past one month, past one year, or the like) in the past.

In a case where the store is expanded into a chain, the sales performance data may be sales performance data of all chain stores, or may be sales performance data of a chain store included in a predetermined store area. The sales performance data is not limited to the sales performance data of the chain store, and may include sales performance data in various stores, online shops, and the like.

The sales performance data 211 is not limited to being stored in the management server 200, and may be stored in the information processing apparatus 110, or may be stored in a place other than the information processing apparatus 110 in the information processing system 100.

<Operation Example of Specifying Unit 113>

Regarding a product that a customer has shown an interest in, such as a product picked up by the customer in a store, the information processing system 100 according to the first example embodiment displays information (ranking information) regarding a rank of a sales performance of the product among a plurality of sales products on the digital signage 130 installed in the vicinity. As a result, the customer's willingness to purchase is increased.

Here, the ranking information is information including a relative rank of a sales performance of a certain product among a plurality of sales products including the product. The ranking information may be information indicating the product and the ranking thereof, or may be information (ranking) including a product having a predetermined rank or higher and the ranking thereof.

In the present example embodiment, the ranking information is generated on the basis of the sales performance data 211 stored in the management server 200 as described above.

Here, a relative rank of a sales performance of a certain product may vary depending on a sales status of the product and an attribute of the customer. That is, the above-described parameters are involved in the relative rank of the sales performance of the certain product. Thus, a process of specifying a parameter for outputting ranking information that satisfies a criterion will be described.

The process of specifying a parameter is performed by the specifying unit 113 illustrated in FIG. 3B.

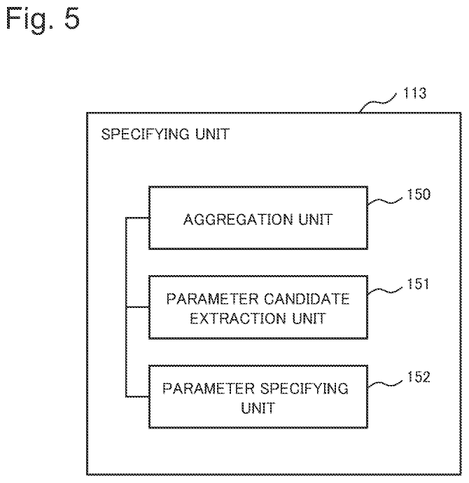

FIG. 5 is a block diagram illustrating examples of functional configuration units of the specifying unit 113. As illustrated in FIG. 5, the specifying unit 113 includes an aggregation unit 150, a parameter candidate extraction unit 151, and a parameter specifying unit 152.

The aggregation unit 150 aggregates the sales performance data 211 stored in the management server 200. On the basis of the aggregated sales performance data 211, the parameter candidate extraction unit 151 extracts, as a parameter candidate, a parameter whose sales performance satisfies a predetermined criterion (hereinafter, also referred to as “sales performance criterion”) regarding a target product to be described later. The sales performance criterion corresponds to a second criterion.

The parameter specifying unit 152 compares sales performances of the target product associated with the extracted parameter candidate between sales performances of a plurality of sales products including the target product, and specifies a parameter with which a rank of the target product satisfies a predetermined criterion (hereinafter, also referred to as a “ranking criterion”). The ranking criterion corresponds to the first criterion. The parameter specifying unit 152 stores the specified parameter in a storage means (not illustrated).

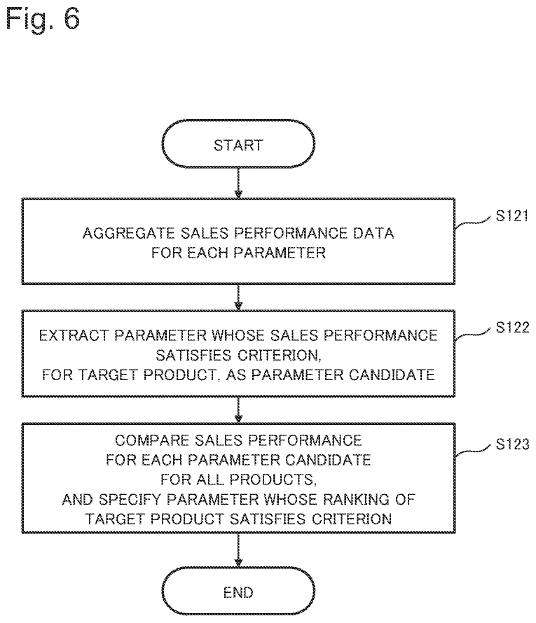

FIG. 6 is a flowchart illustrating operation of the specifying unit 113. The operation of the specifying unit 113 will be described with reference to FIG. 6.

(Step S121)

The aggregation unit 150 aggregates the sales performance data 211 stored in the management server 200. The aggregation unit 150 performs aggregation, for example, for each brand of products.

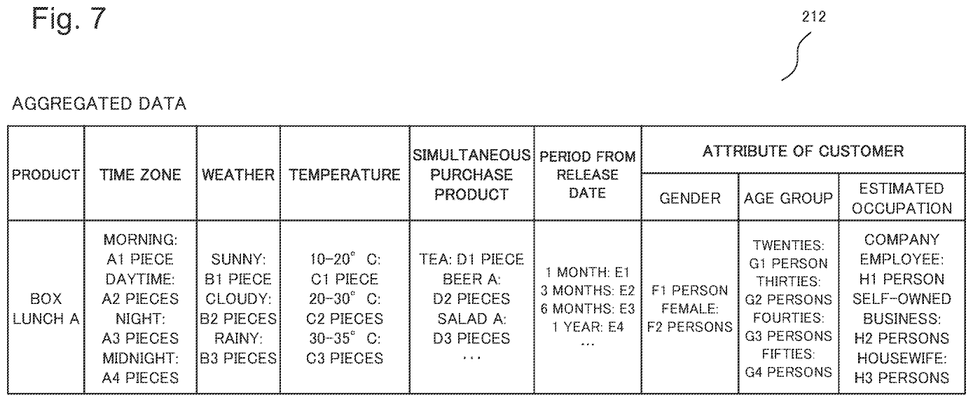

FIG. 7 is a diagram illustrating an example of aggregated data 212 that is data obtained by aggregating the sales performance data 211. FIG. 7 illustrates aggregated data of a box lunch A.

The aggregation unit 150 aggregates the sales performance data 211 in association with the parameter. For example, the aggregation unit 150 may perform aggregation for each parameter associated with the sales performance data 211, and a category generated from a value of the parameter. FIG. 7 illustrates that, regarding parameters “time zone”, “weather”, “temperature”, “simultaneous purchase product”, “period from release date”, and “gender”, “age group”, and “estimated occupation” that are “attributes of customer”, aggregation is performed for each category constituting them.

For example, the aggregation unit 150 may aggregate the sales performances for each category of “morning”, “daytime”, “night”, and “midnight” determined for each predetermined time regarding the parameter “time zone”. For example, the aggregation unit 150 may aggregate the number of products sold as the sales performance.

For the “simultaneous purchase product”, the aggregation unit 150 may aggregate the number of products sold for each brand of products simultaneously purchased. For the “period from release date”, for example, the aggregation unit 150 may aggregate the number of products sold in each of “one month”, “three months”, “six months”, and “one year” from the release date. For the “age group” in the “attributes of customer”, the aggregation unit 150 may aggregate the number of products sold to customers in each age group of “twenties”, “thirties”, “forties”, and “fifties”. A specific value (for example, male, female) of each parameter and a category (for example, “morning”, “daytime”, “night”, and “midnight”) generated from the value of the parameter are also referred to as parameters. The category may be set in advance together with setting of the parameter.

The aggregation unit 150 also perform aggregation for other products included in the sales performance data 211 for each brand as described above. The aggregation unit 150 may perform aggregation for all products included in the sales performance data 211, or may perform aggregation for some products. For example, aggregation of the sales performance data 211 is performed for each target product. The aggregation is not limited to being performed for each parameter, and may be performed for each of a plurality of parameters (parameter sets). For example, sales performances may be aggregated for each parameter set of “male” and “twenties”.

The aggregation unit 150 may aggregate the sales performance data 211 as described above, and store the generated aggregated data in the management server 200. The aggregated data may be stored in the information processing apparatus 110, or may be stored in a place other than the information processing apparatus 110 in the information processing system 100.

(Step S122)

Subsequently, the parameter candidate extraction unit 151 extracts, as a parameter candidate, a parameter whose sales performance satisfies the sales performance criterion for the target product on the basis of the aggregated data 212 generated by the aggregation unit 150.

Here, the target product is a product (brand) as a target for which the ranking information is presented to the customer. The target product is, for example, a product displayed on a product shelf in the store, in which the digital signage 130 is installed in the vicinity. It is sufficient that the target product is set in advance.

The parameter whose sales performance satisfies the sales performance criterion is a parameter whose sales performance is relatively good. Any criterion may be set as the sales performance criterion. For example, regarding the number of products sold, any criterion may be set, for example, the number of products sold is greater than or equal to a predetermined number, a predetermined number of products sold in descending order, the number of products sold is greater than others by a predetermined ratio or more, a period in which an increase rate of the number of products sold is higher than others, and the like. Alternatively, regarding the attribute, for example, the number of people is larger than other attributes, or the like may be set. A plurality of criteria may be set as the sales performance criterion.

For example, in a case where “box lunch A” is set as the target product, the parameter candidate extraction unit 151 extracts, as a parameter candidate, a parameter of which the sales performance of the box lunch A satisfies the sales performance criterion. In a case where a predetermined number of parameter candidates that satisfy the sales performance criteria cannot be extracted, the parameter candidate extraction unit 151 may change the sales performance criterion, and extract the predetermined number of parameter candidates.

The parameter candidate extraction unit 151 performs processing of step S122 for each target product.

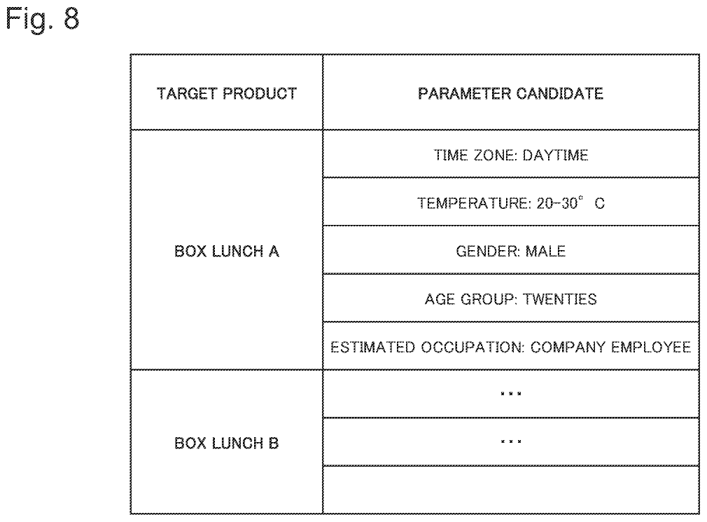

FIG. 8 is a diagram illustrating an example of the extracted parameter candidates. FIG. 8 illustrates that, for example, regarding “box lunch A”, parameters whose sales performance satisfies the sales performance criterion are extracted as parameter candidates, which are “time zone: daytime”, “temperature: 20-30° C.”, “gender: male”, “age group: twenties”, and “estimated occupation: company employee”. The parameter candidate extraction unit 151 extracts a parameter candidate for each target product. The parameter candidate to be extracted is not limited to being extracted for each parameter, and may be extracted for each of a plurality of parameters (parameter sets). For example, a parameter set such as “male” and “twenties” may be extracted as parameter candidates.

(Step S123)

Subsequently, the parameter specifying unit 152 compares sales performances associated with the extracted parameter candidates for each product, and specifies a parameter of which the rank of the target product satisfies the ranking criterion, from the parameter candidates. The ranking criterion may be set in advance, and is, for example, a predetermined rank.

Here, the product whose sales performance is compared may be all the products included in the sales performance data 211, but is not limited thereto. For example, the product may be a product in the same category as the target product, or may be a product displayed on the same shelf as the target product. As described above, the product may be a product sold in the same store, or may be a product sold in another store (for example, a store in a predetermined area). The product whose sales performance is compared may be determined in advance. In the present example embodiment, comparison with all products included in the sales performance data 211 will be described as an example.

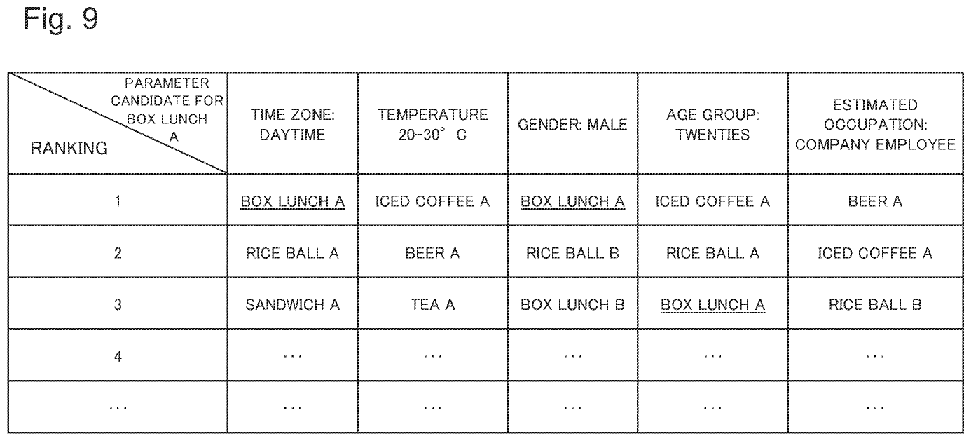

First, the parameter specifying unit 152 sorts sales performances of all the products using the extracted parameter candidate as a condition (key) for each product. FIG. 9 is a diagram illustrating an example of a result of sorting sales performances of all the products using parameter candidates related to “box lunch A” as the condition. FIG. 9 illustrates an example in which products are arranged from the first place in descending order of sales performances, for each parameter candidate. For example, it is indicated that in the sales performances when “time zone” is “daytime”, “box lunch A” is in the first place, “rice ball A” is in the second place, and “sandwich A” is in the third place.

The parameter specifying unit 152 specifies a parameter with which the target product satisfies the ranking criterion from a result of sorting. For example, in a case where “third place” is set as the ranking criterion, the parameter specifying unit 152 specifies a parameter included in “third place” regarding “box lunch A”. In the example of FIG. 9, regarding parameters of “time zone: daytime”, “gender: male”, and “age group: twenties”, the sales performance of “box lunch A” is within the third place (underlined in FIG. 9). The parameter specifying unit 152 therefore specifies “time zone: daytime”, “gender: male”, and “age group: twenties” as parameters. The identified parameter is also referred to as a “specific parameter”.

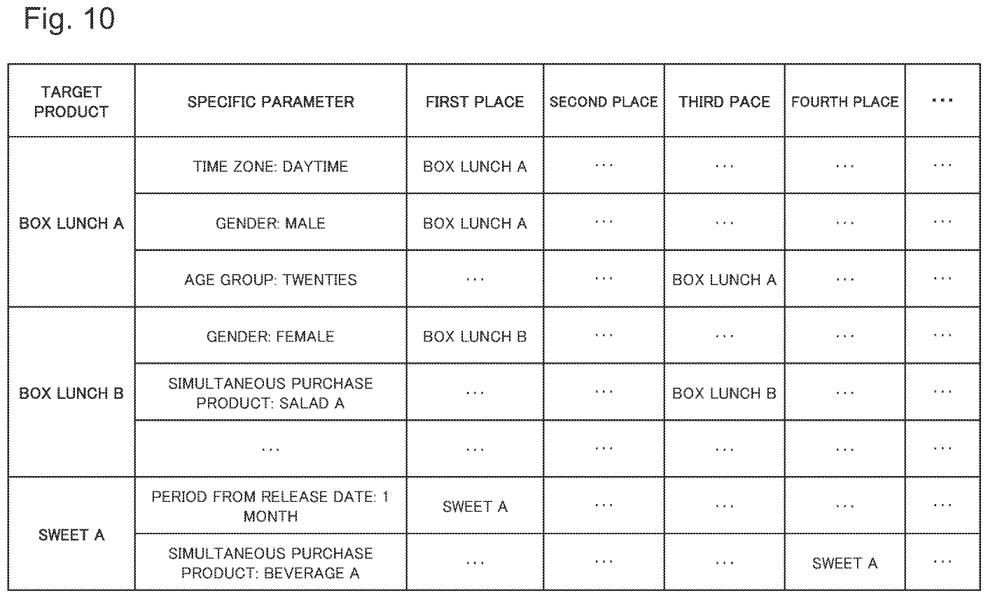

The parameter specifying unit 152 specifies the parameter as described above for each target product from which the parameter candidate has been extracted. The parameter specifying unit 152 stores the result of sorting the sales performances, and the specified parameter in association with each other, for each target product. Information in which the result of sorting the sales performances and the specified parameter are associated with each other is also referred to as “specific parameter information”. FIG. 10 is a diagram illustrating an example of the specific parameter information. As illustrated in FIG. 10, the specific parameter information includes, for each target product, a specified parameter and a result of sorting sales performances regarding the parameter. It is sufficient that the result of sorting the sales performances includes information of products up to a predetermined rank. For example, it is sufficient that information of products up to at least a rank indicated by the ranking criterion is included.

The ranking criterion may be changeable. The parameter specifying unit 152 may change the ranking criterion in a case where there is no parameter with which the target product satisfies the ranking criterion set in advance. For example, in a case where the ranking criterion is set to, for example, “third place” and there is no parameter with which the target product comes within the “third place”, the parameter specifying unit 152 may change the ranking criterion to “tenth place” and search again for a parameter with which the target product comes within the tenth place.

The parameter specifying unit 152 may store the specific parameter information in the information processing apparatus 110, may store the specific parameter information in a place other than the information processing apparatus 110 in the information processing system 100, or may store the specific parameter information in the management server 200.

Parameter specifying processing may be executed at any timing prior to output of the ranking information of the featured product.

<Operation Example of Information Processing Apparatus 110>

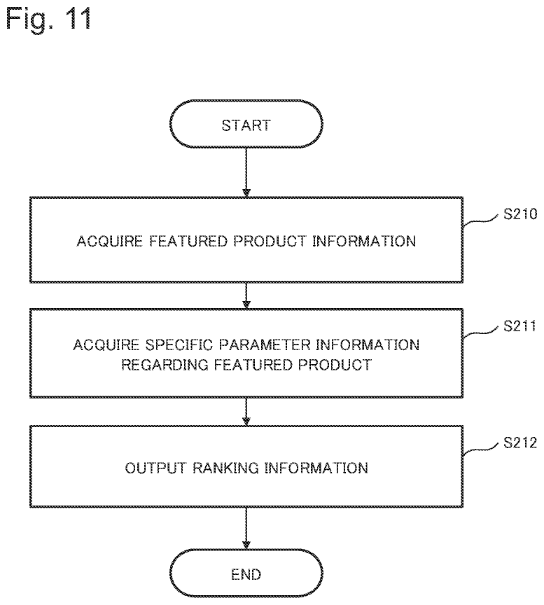

FIG. 11 is a flowchart illustrating operation of the information processing apparatus 110 according to the first example embodiment. The operation of the information processing apparatus 110 will be described with reference to FIG. 11. It is assumed that the parameter specifying processing described above is performed by the specifying unit 113, and specific parameter information for each target product is stored in a storage means (not illustrated) in the information processing apparatus 110. Here, as an example, it is assumed that the specific parameter information illustrated in FIG. 10 is stored.

Here, as illustrated in FIG. 2, it is assumed that the imaging device 120 images a product arrangement area of the product shelf 10, and an area where a customer looks at a product or picks up a product, in front of the product shelf 10. The following processing is executed at a timing when the customer visits the store.

(Step S210)

The acquisition unit 111 acquires information (featured product information) indicating a product of interest to a customer visiting a store. The acquisition unit 111 acquires the featured product information from the image analysis device 140, for example. Here, the image analysis device 140 will be described.

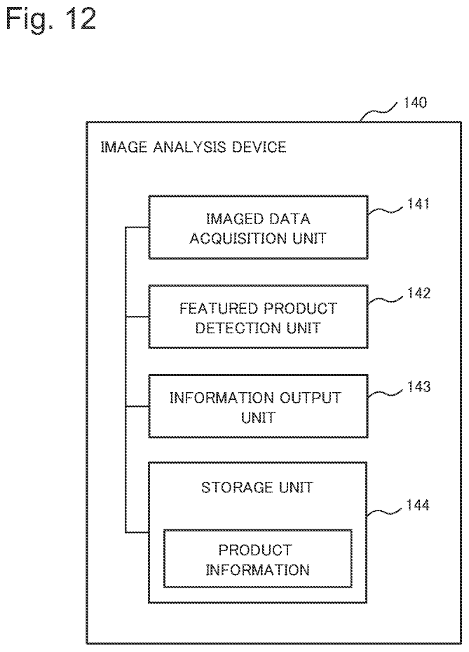

FIG. 12 is a block diagram illustrating an example of a configuration of the image analysis device 140. As illustrated in FIG. 12, the image analysis device 140 includes an imaged data acquisition unit 141, a featured product detection unit 142, an information output unit 143, and a storage unit 144.

The imaged data acquisition unit 141 acquires imaged data from the imaging device 120. The featured product detection unit 142 detects a customer on the basis of the acquired imaged data, and in a case where there is a product of interest to the customer, detects the product. In the present example embodiment, the product picked up by the customer is detected as a product of interest to the customer, but the product of interest to the customer is not limited thereto.

The information output unit 143 outputs information of the product detected by the featured product detection unit 142 to the information processing apparatus 110.

The storage unit 144 stores product information regarding a product handled in the store, for example, an ID, product name, and feature value of the product. The feature value is extracted in advance from an image of the product. The product information stored in the storage unit 144 may be product information of a product displayed in the store. The product information is not limited to being stored in the image analysis device 140, and may be stored in a place other than the image analysis device 140 in the information processing system 100. The image analysis device 140 may use the product information included in the sales performance data 211 stored in the management server 200. At this time, the product information included in the sales performance data 211 includes the feature value for each product.

The featured product detection unit 142 detects the featured product on the basis of the imaged data acquired by the imaged data acquisition unit 141. Specifically, the featured product detection unit 142 tracks (traces) the customer on the basis of the imaged data and recognizes the customer's action. For example, the featured product detection unit 142 recognizes that the customer picks up the product, from an image at hand of the customer, or the like.

When recognizing that the customer picks up the product, the featured product detection unit 142 extracts the feature value of the product. The featured product detection unit 142 identifies the product by collating the extracted feature value with the feature value included in the product information stored in the storage unit 144. The featured product detection unit 142 reads the product name of the identified product. An existing technique may be used for detection of a person based on imaged data, tracking, and detection of a product taken in hand by the person.

The information output unit 143 outputs the product name of the featured product detected by the featured product detection unit 142 to the information processing apparatus 110 as featured product information.

The acquisition unit 111 acquires the featured product information from the image analysis device 140.

(Step S211)

The output unit 112 acquires the specific parameter information associated with the product name of the featured product acquired by the acquisition unit 111, from the storage means.

(Step S212)

The output unit 112 outputs the ranking information to the digital signage 130 on the basis of the acquired specific parameter information.

Here, the output unit 112 may output all or part of information regarding the rank associated with the product name of the featured product in the specific parameter information stored in the storage means, as the ranking information. For example, in a case where a plurality of parameters is specified for the featured product, the ranking information regarding the parameter with which the rank of the featured product is the highest may be output.

For example, it is assumed that the featured product is “sweet A”. As illustrated in FIG. 10, two parameters of “period from release date: one month” and “simultaneous purchase product: beverage A” are specified for “sweet A”. At this time, the output unit 112 may output, to the digital signage 130, ranking information regarding “period from release date: one month” with which “sweet A” has the highest rank.

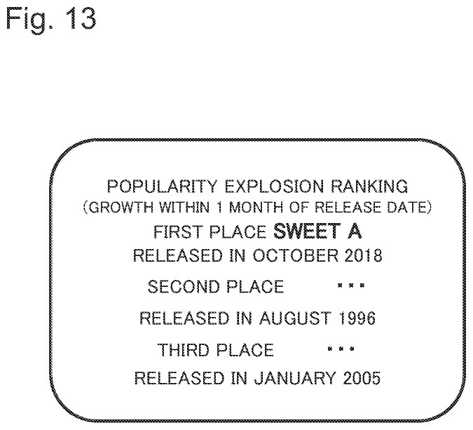

FIG. 13 is a diagram illustrating an example of a screen output to the digital signage 130. FIG. 13 illustrates that the sales performance of “period from release date: one month” of “sweet A” is in the first place. The output unit 112 may output not only the product name of the product included in the specific parameter information but also related information. For example, as illustrated in FIG. 13, the release date of each product may be read from the product information included in the sales performance data 211 and output.

The output unit 112 may output products up to a predetermined rank such as the top three places from the specific parameter information. The output unit 112 may also change the number of products to be output depending on the rank of the featured product. For example, in a case where the highest rank of the featured product is, for example, the third place, products up to top three places may be output, and in a case where the highest rank is, for example, the eighth place, products up to top ten places may be output.

In a case where the ranking criterion is changed by the parameter specifying unit 152, the output unit 112 may change the number of products whose rank is displayed on the digital signage 130 along with the change. For example, the output unit 112 may display three products in the top three when the ranking criterion is “third place”, and display ten products in the top ten when the ranking criterion is changed to “tenth place”.

As described above, according to the first example embodiment, on the basis of the sales performance data associated with the parameter regarding the sales performance of the plurality of sales products, the information processing apparatus 110 specifies and stores the parameter with which the rank regarding the sales performance of the product satisfies the criterion. Then, regarding the featured product of interest to the customer visiting to the store, the ranking information, that satisfies a first criterion, regarding the parameter is output to the digital signage 130.

By adopting this configuration, according to the first example embodiment, an effect is obtained of enabling a customer to easily grasp the ranking regarding a product of interest to the customer. For example, by causing the digital signage 130 to generate ranking in which a product of interest to the customer has a predetermined rank or higher, it is possible to increase the customer's willingness to purchase.

The image analysis device 140 may have a function of specifying a customer on the basis of imaged data. In this case, the information processing apparatus 110 may cooperate with the POS system and store information indicating whether the customer has purchased the featured product in the sales performance data. Specifically, the image analysis device 140 may specify the customer by, for example, face authentication processing. That is, the image analysis device 140 may specify the customer using the imaged data and a database in which the feature value of the appearance of the customer is registered in advance. The image analysis device 140 may detect that the customer has purchased the featured product by tracking the imaged data. When the image analysis device 140 detects that the customer has purchased the featured product, the information processing apparatus 110 may notify the POS system of an identification information of the customer and that the customer has purchased the featured product. The POS system may store the sales performance data of the featured product in association with the identification information of the customer who has purchased the product and the fact that the product is a product of interest to the customer. Alternatively, the information processing apparatus 110 may store the identification information of the customer and information indicating that the customer has purchased the featured product in association with each other.

<Basic Configuration of First Example Embodiment>

Next, a basic configuration of the first example embodiment will be described.

As illustrated in FIG. 3A, the information processing apparatus 110 includes the acquisition unit 111 and the output unit 112. The acquisition unit 111 acquires the information indicating the featured product including the product of interest to the customer visiting the store. The output unit 112 outputs the ranking information regarding the sales performance of the featured product and regarding the parameter that satisfies the first criterion.

According to the basic configuration of the first example embodiment, regarding the product of interest to the customer, the customer can easily grasp the ranking. This is because the information processing apparatus 110 acquires the information indicating the featured product including the product of interest to the customer visiting the store, and outputs the ranking information regarding the sales performance of the featured product and regarding the parameter that satisfies the first criterion.

### Second Example Embodiment

An information processing system according to a second example embodiment will be described. The reference numerals common to those given in the drawings of the first example embodiment denote the same functional configuration units, and redundant description of the functional configuration units will be omitted.

In the second example embodiment, a configuration will be described in which the information processing system 100 in the first example embodiment includes an image analysis device 140A instead of the image analysis device 140. The information processing apparatus 110 according to the second example embodiment has a function of selecting ranking information to be output to the digital signage 130 on the basis of information acquired from the image analysis device 140A.

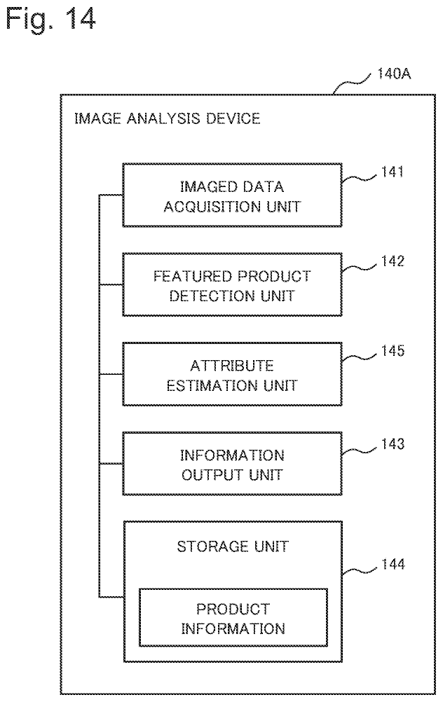

FIG. 14 is a block diagram illustrating a configuration of the image analysis device 140A. As illustrated in FIG. 14, the image analysis device 140A includes an attribute estimation unit 145 in addition to the configuration of the image analysis device 140. In FIG. 14, the reference numerals common to those in FIG. 12 denote the same functional configuration units, and redundant description of the functional configuration units is omitted.

On the basis of imaged data acquired by the imaged data acquisition unit 141, the attribute estimation unit 145 detects a customer who picks up a product, and estimates an attribute of the customer. The attribute of the customer to be estimated may be an attribute of the customer included as a parameter in the sales performance data 211. Here, an example will be described of a method of estimating age and gender from the imaged data of the customer. First, learning data is created in advance in which a feature value of a face of a customer is associated with age and gender, and is stored in a storage device (not illustrated) as a database. The attribute estimation unit 145 extracts the face from the imaged data acquired from the imaging device 120 and calculates a feature value of the extracted face. The attribute estimation unit 145 estimates the age and gender of the customer by comparing the calculated feature value with the feature value of the database. Clothes of the customer can be estimated, similarly. The occupation can be similarly estimated from the clothes of the customer. The method of estimating the attribute of the customer is not limited to the above-described method, and various existing techniques can be used.

The information output unit 143 outputs the product name of the featured product detected by the featured product detection unit 142 and the attribute of the customer estimated by the attribute estimation unit 145 to the information processing apparatus 110.

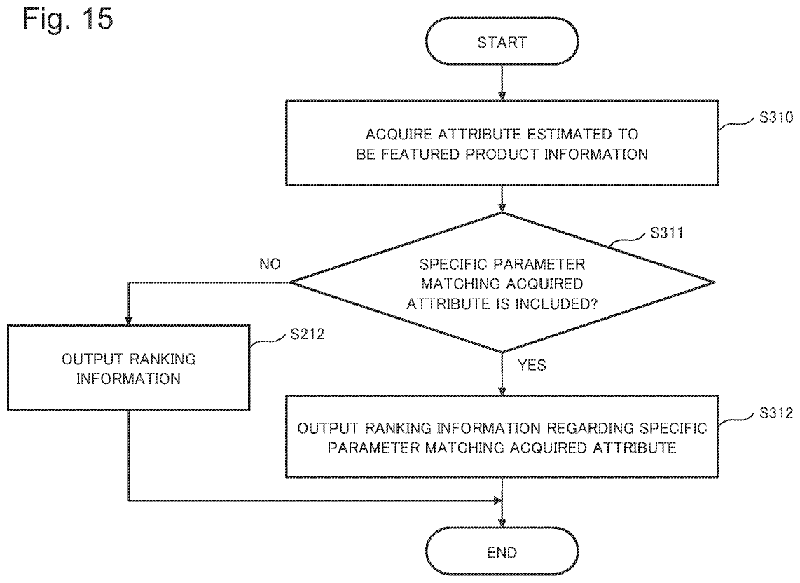

FIG. 15 is a flowchart illustrating operation of the information processing system 100 according to the second example embodiment including the image analysis device 140A.

(Step S310)

Similarly to step S210 in FIG. 11, the acquisition unit 111 acquires the featured product information that is information indicating the product of interest to the customer visiting the store. The acquisition unit 111 also acquires the estimated attribute of the customer from attribute estimation unit 145. When acquiring the featured product information and the attribute of the customer from the image analysis device 140A, the acquisition unit 111 notifies the output unit 112.

(Step S311)

The output unit 112 acquires the specific parameter information associated with the product indicated by the acquired featured product information, from the storage means. Then, the output unit 112 determines whether the specific parameter matching the acquired attribute is included in the specific parameter information.

(Step S312)

In a case where the specific parameter matching the acquired attribute is included in the specific parameter information, the output unit 112 outputs the ranking information regarding the specific parameter to the digital signage 130.

(Step S212)

On the other hand, in a case where the specific parameter matching the acquired attribute is not included in the specific parameter information, the ranking information regarding the specific parameter included in the specific parameter information is output to the digital signage 130.

An example will be described in which, for example, the specific parameter information illustrated in FIG. 10 is stored in the storage means, the featured product is “box lunch A”, and the estimated attributes of the customer are “male” and “fifties”.

The specific parameter information illustrated in FIG. 10 includes the parameter “male” among the estimated attributes of the customer for “box lunch A”. The output unit 112 therefore outputs, to the digital signage 130, ranking information regarding “gender: male” that matches the attribute of the customer, that is, ranking information indicating that “box lunch A” is in the “first place” in sales performance for “gender: male”.

In a case where the specific parameter matching the sales status at the time of outputting the ranking information is included in the specific parameter information, the output unit 112 may output the ranking information regarding the specific parameter. For example, in a case where the “time zone” at the time of outputting the ranking information belongs to the “daytime”, the output unit 112 may output the ranking information regarding the specific parameter “time zone: daytime” to the digital signage 130.

In a case where the specific parameter information includes a plurality of specific parameters having the same customer attribute and sales status, the output unit 112 may also output ranking information regarding all the specific parameters to the digital signage 130, or may partially output the ranking information.

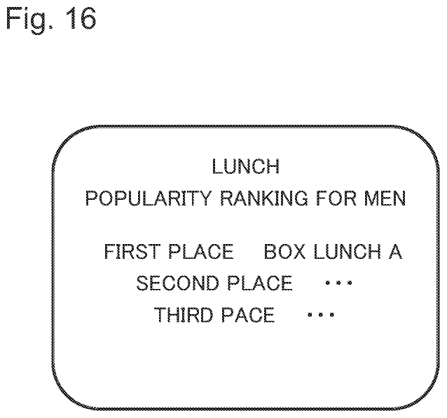

FIG. 16 is a diagram illustrating another example of the screen output to the digital signage 130. In FIG. 16, the ranking information regarding the specific parameter of which the attribute of the customer and the sales status match is output. That is, information is output indicating that “box lunch A” is in the “first place” in sales performance (popularity) in “daytime”, and in “male”.

As described above, according to the second example embodiment, in a case where the specific parameter matching the estimated attribute of the customer or the sales status is stored in the storage means, the information processing apparatus 110 preferentially outputs the ranking information based on the attribute or the sales status to the digital signage 130. By adopting this configuration, according to the second example embodiment, it is possible to output ranking information having a higher appeal effect for a product of interest to the customer, and thus, an effect is obtained of further increasing the customer's willingness to purchase.

When a parameter for preferentially outputting the ranking information is set in advance and there is a plurality of parameters satisfying the ranking criterion, ranking information may be output regarding the parameter set for preferential output.

### Other Modifications

In addition, various modifications are conceivable in the present example embodiment.

For example, the featured product is not limited to a product detected to be picked up by a customer on the basis of the imaged data. For example, the product detected to be picked up by the customer and a product in the same category as the product may be included as a featured product.

That is, when the featured product information is acquired from the image analysis device 140 (140A), the acquisition unit 111 may read the category to which the product belongs from the product information and set the product belonging to the category as the featured product. In this case, for example, when “box lunch A” is detected as the featured product, a total of sales performances of products in the same category as the category to which the box lunch A belongs (for example, “box lunch”) may be compared with a total of sales performances of products in other categories, and ranking information regarding the category (here, “box lunch”) may be output.

Alternatively, the product detected to be picked up by the customer and a product on a product shelf on which the product is displayed may be included as a featured product. In addition, the featured product may be determined depending on various situations.

It is not limited to specifying the product picked up by the customer as the featured product. For example, an expression (delight, surprise, and the like) of the customer may be detected from the imaged data, and the featured product may be specified. A microphone may be provided in the imaging device 120, and the featured product may be specified by recognizing the voice of the customer input to the microphone by a voice recognition unit. Alternatively, a weight sensor may be installed on a product shelf, and a product displayed on the product shelf where weight is reduced may be specified as the featured product. Alternatively, the featured product may be specified by detecting a line of sight of the customer and recognizing which area the customer is looking at. In this case, for example, a line-of-sight sensor may be attached to the product shelf 10, and a direction of the line of sight of the customer may be detected on the basis of a detection result of the line-of-sight sensor. The featured product may include a product or a category of the product, or a product on a product shelf in the direction of the line of sight of the customer.

The parameter specifying processing by the specifying unit 113 is not limited to being performed in advance before the detection of the featured product information. For example, the parameter specifying processing may be performed on the featured product information at the timing when the featured product information is detected, and the ranking information regarding the specified parameter may be output. Alternatively, the parameter specifying processing may be performed in advance before the detection of the featured product information, and the comparison of the sales performances associated with the parameter and the calculation and output of the rank of the featured product may be performed at the timing when the featured product information is detected.

The processing in each example embodiment is not limited to being executed in the processing unit described above. For example, the detection of the featured product is not limited to being executed by the image analysis device 140, and may be executed by the acquisition unit 111, for example. In this case, the acquisition unit 111 acquires the imaged data from the imaging device 120, detects the featured product, and notifies the output unit 112 of information of the detected featured product.

The parameter specifying processing is not limited to being executed in the specifying unit 113 of the information processing apparatus 110. For example, a second information processing apparatus having the function of the specifying unit 113 illustrated in FIG. 5 may be provided in the information processing system 100, and the parameter specifying processing may be executed in the second information processing apparatus. In this case, the aggregation unit of the second information processing apparatus reads the sales performance data 211 from the management server 200, and the parameter specifying unit 152 outputs the specified parameter to the information processing apparatus 110. The specifying unit 113 is not limited to being included in FIG. 3B, and may be included other than the output unit 112 in the information processing apparatus 110.

<Hardware Configuration>

In each of the above-described example embodiments, some or all of the functional configuration units of each device (Information processing apparatus 110, image analysis device 140, and the like) may be implemented by any combination of a computer 500 and a program.

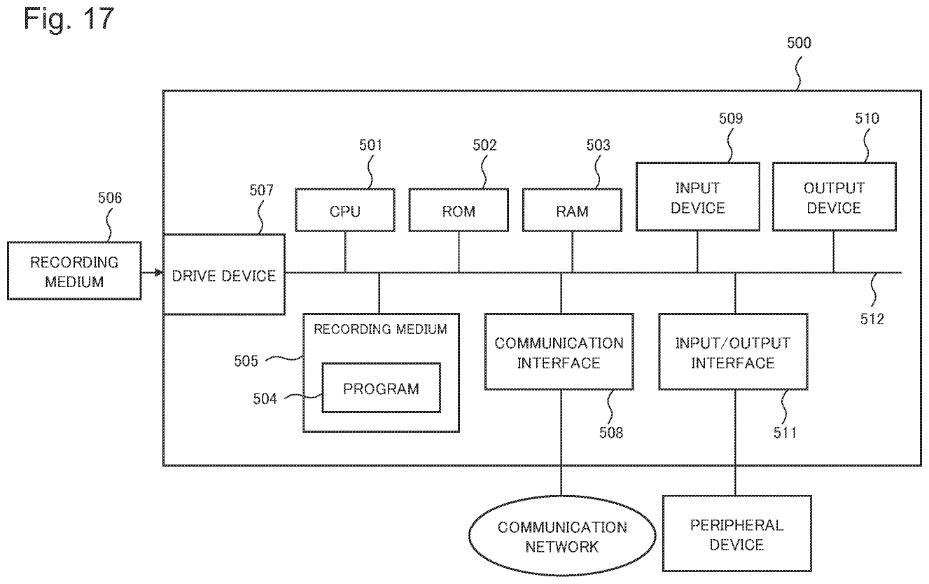

FIG. 17 is a diagram illustrating an example of a hardware configuration of the computer 500. Referring to FIG. 17, the computer 500 includes, for example, a central processing unit (CPU) 501, a read only memory (ROM) 502, a random access memory (RAM) 503, a program 504, a storage device 505, a drive device 507, a communication interface 508, an input device 509, an output device 510, an input/output interface 511, and a bus 512.

The program 504 includes an instruction for implementing each function of each device. The program 504 is stored in advance in the ROM 502, the RAM 503, and the storage device 505. The CPU 501 implements each function of each device by executing instructions included in the program 504. For example, the CPU 501 of the information processing apparatus 110 executes an instruction included in the program 504 to implement the functions of the acquisition unit 111, the output unit 112, the specifying unit 113, the aggregation unit 150, the parameter candidate extraction unit 151, and the parameter specifying unit 152. The RAM 503 may store data to be processed in each function of each device. For example, the RAM 503 of the information processing apparatus 110 may store the ranking information and the like.

The drive device 507 reads and writes a recording medium 506. The communication interface 508 provides an interface with a communication network. The input device 509 is, for example, a mouse, a keyboard, or the like, and receives an input of information from an administrator or the like. The output device 510 is, for example, a display, and outputs (displays) information to the administrator or the like. The input/output interface 511 provides an interface with a peripheral device. The bus 512 connects the components of the hardware to each other. The program 504 may be supplied to the CPU 501 via a communication network, or may be stored in the recording medium 506 in advance, read by the drive device 507, and supplied to the CPU 501.

The hardware configuration illustrated in FIG. 17 is an example, and other components may be added or some components may not be included.

There are various modifications of the implementation method of each device. For example, each device may be implemented by any combination of a computer and a program different for each component. A plurality of components included in each device may be implemented by any combination of one computer and programs.

Some or all of the components of each device may be implemented by general-purpose or dedicated circuitry including a processor or the like, or a combination thereof. These circuits may be configured by a single chip or may be configured by a plurality of chips connected together via a bus. Some or all of components of each device may be implemented by a combination of the above-described circuit or the like and programs.

In a case where some or all of components of each device are implemented by a plurality of computers, circuits, and the like, the plurality of computers, circuits, and the like may be arranged in a centralized manner or in a distributed manner.

Although the present disclosure has been described with reference to the example embodiments, the present disclosure is not limited to the above-described example embodiments. For example, the configurations in the example embodiments can be combined with each other without departing from the scope of the present disclosure. The configuration in each example embodiment can be modified in various ways that can be understood by those skilled in the art without departing from the scope of the present disclosure. For example, an example embodiment in which a part of the configuration of any example embodiment is added to another example embodiment, or an example embodiment in which a part of the configuration of any example embodiment is replaced with a part of the configuration of another example embodiment is also an example embodiment to which the present disclosure can be applied.

In the multiple flowcharts used in the above description, multiple steps (processes) are described in order, but the execution order of the steps executed in each example embodiment is not limited to the described order. In each example embodiment, the order of the illustrated steps can be changed as long as there is no problem in terms of content.

A processing method of causing a recording medium to record a program for operating the configuration of each of the above-described example embodiments to implement the functions of the example embodiments, reading the program recorded in the recording medium as a code, and executing the program in a computer is also included in the scope of each of the above-described example embodiments. That is, a computer-readable recording medium is also included in the scope of each example embodiment. Not only a recording medium recording the above-described computer program, but also the computer program itself is included in each example embodiment.

Examples of the recording medium include a floppy (registered trademark) disk, a hard disk, an optical disk, a magneto-optical disk, a compact disc-read only memory (CD-ROM), a magnetic tape, a nonvolatile memory card, and a ROM. The example embodiments are not limited to those in which processing is executed by a single program recorded in the recording medium, and those in which processing is executed on an operating system (OS) in cooperation with functions of other software and an extension board are also included in the scope of the example embodiments.

Some or all of the above example embodiments may be described as the following supplementary notes, but are not limited to the following.

(Supplementary Note 1)

An information processing apparatus including:

an acquisition means for acquiring information indicating a featured product including a product of interest to a customer visiting a store; and

an output means for outputting ranking information, that satisfies a first criterion, regarding a sales performance of the featured product and regarding a parameter.

(Supplementary Note 2)

The information processing apparatus according to supplementary note 1, in which

the output means specifies a parameter with which the ranking information regarding the sales performance of the featured product satisfies the first criterion, based on a sales performance associated with the parameter regarding sales of each of a plurality of sales products including the featured product, and outputs the ranking information regarding the specified parameter.

(Supplementary Note 3)

The information processing apparatus according to supplementary note 2, in which

the output means extracts, as a parameter candidate, a parameter with which the sales performance of the featured product satisfies a second criterion, based on the sales performance, compares a sales performance of each of the plurality of sales products associated with the extracted parameter candidate, and specifies, from the parameter candidate, a parameter with which ranking information regarding the sales performance of the featured product satisfies the first criterion.

(Supplementary Note 4)

The information processing apparatus according to any one of supplementary notes 1 to 3, in which

the output means outputs ranking information when the ranking information regarding the sales performance with which an attribute matching an attribute of the customer is associated as the parameter satisfies the first criterion.

(Supplementary Note 5)

The information processing apparatus according to any one of supplementary notes 1 to 4, in which

the output means outputs ranking information when the ranking information regarding the sales performance with which a sales status matching a sales status of the featured product is associated as the parameter satisfies the first criterion.

(Supplementary Note 6)

The information processing apparatus according to any one of supplementary notes 1 to 5, in which

the output means outputs ranking information higher than other pieces of ranking information among pieces of ranking information regarding sales performance associated with a plurality of parameters satisfying the first criterion.

(Supplementary Note 7)

The information processing apparatus according to any one of supplementary notes 1 to 6, in which

the output means changes the first criterion in a case where the parameter with which the ranking information regarding the sales performance of the featured product satisfies the first criterion is not specified.

(Supplementary Note 8)

The information processing apparatus according to any one of supplementary notes 1 to 7, in which

a rank is determined in advance as the first criterion, and

the output means specifies the parameter with which a rank regarding the sales performance of the featured product is equal to or higher than the rank determined in advance.

(Supplementary Note 9)

The information processing apparatus according to supplementary note 8, in which

the output means outputs ranks regarding sales performances of a plurality of sales products including the featured product, the ranks being equal to or higher than the rank determined in advance as the first criterion, regarding the specified parameter.

(Supplementary Note 10)

The information processing apparatus according to supplementary note 9, in which

a rank is determined in advance as the first criterion, and

the output means changes the rank determined as the first criterion in a case where the output means is not able to specify the parameter with which a rank regarding the sales performance of the featured product is equal to or higher than the rank determined in advance, and

changes a number of the sales performance of the sales product whose rank is output based on the changed rank.

(Supplementary Note 11)

The information processing apparatus according to any one of supplementary notes 1 to 10, in which

the output means outputs the ranking information to a display device installed in the store.

(Supplementary Note 12)

A display system including:

an information processing apparatus including an acquisition means for acquiring information indicating a featured product including a product of interest to a customer visiting a store, and

an output means for outputting ranking information, that satisfies a first criterion, regarding a sales performance of the featured product and regarding a parameter; and

a display device that is installed in the store and displays the ranking information output by the output means.

(Supplementary Note 13)

An information processing method including:

acquiring information indicating a featured product including a product of interest to a customer visiting a store; and

outputting ranking information, that satisfies a first criterion, regarding a sales performance of the featured product and regarding a parameter.

(Supplementary Note 14)

A recording medium recording a program for causing a computer to execute:

a process of acquiring information indicating a featured product including a product of interest to a customer visiting a store; and

a process of outputting ranking information, that satisfies a first criterion, regarding a sales performance of the featured product and regarding a parameter.

This application is based upon and claims the benefit of priority from Japanese patent application No. 2019 055882, filed on Mar. 25, 2019, the disclosure of which is incorporated herein in its entirety by reference.

### REFERENCE SIGNS LIST

100 Information processing system
110 Information processing apparatus
111 Acquisition unit
112 Output unit
113 Specifying unit
120 Imaging device
130 Digital signage
140 Image analysis device
200 Management server

What is claimed is:

1. An information processing apparatus comprising:
a memory storing instructions; and
one or more processors configured to execute the instructions to:
acquire information indicating a featured product including a product of interest to a customer visiting a store; and
output ranking information, that satisfies a first criterion, regarding a sales performance of the featured product and regarding a parameter.

2. The information processing apparatus according to claim 1, wherein
the one or more processors are further configured to execute the instructions to:
specify the parameter with which the ranking information regarding the sales performance of the featured product satisfies the first criterion, based on a sales performance associated with the parameter regarding sales of each of a plurality of sales products including the featured product; and
output the ranking information regarding the specified parameter.

3. The information processing apparatus according to claim 2, wherein
the one or more processors are further configured to execute the instructions to:
extract, as a parameter candidate, a parameter with which the sales performance of the featured product satisfies a second criterion, based on the sales performance, compare a sales performance of each of the plurality of sales products associated with the extracted parameter candidate, and specify, from the parameter candidate, a parameter with which ranking information regarding the sales performance of the featured product satisfies the first criterion.

4. The information processing apparatus according to claim 1, wherein
the one or more processors are further configured to execute the instructions to:
output ranking information when the ranking information regarding the sales performance with which an attribute matching an attribute of the customer is associated as the parameter satisfies the first criterion.

5. The information processing apparatus according to claim 1, wherein
the one or more processors are further configured to execute the instructions to:
output ranking information when the ranking information regarding the sales performance with which a sales status matching a sales status of the featured product is associated as the parameter satisfies the first criterion.

6. The information processing apparatus according to claim 1, wherein
the one or more processors are further configured to execute the instructions to:
output ranking information higher than other pieces of ranking information among pieces of ranking information regarding sales performance associated with a plurality of parameters satisfying the first criterion.

7. The information processing apparatus according to claim 1, wherein
the one or more processors are further configured to execute the instructions to:
change the first criterion in a case where the parameter with which the ranking information regarding the sales performance of the featured product satisfies the first criterion is not specified.

8. The information processing apparatus according to claim 1, wherein
a rank is determined in advance as the first criterion, and
the one or more processors are further configured to execute the instructions to:
specify the parameter with which a rank regarding the sales performance of the featured product is equal to or higher than the rank determined in advance.

9. The information processing apparatus according to claim 8, wherein
the one or more processors are further configured to execute the instructions to:
output ranks regarding sales performances of a plurality of sales products including the featured product, the ranks being equal to or higher than the rank determined in advance as the first criterion, regarding the specified parameter.

10. The information processing apparatus according to claim 9, wherein
a rank is determined in advance as the first criterion, and
the one or more processors are further configured to execute the instructions to:
change the rank determined as the first criterion in a case where the output means is not able to specify the parameter with which a rank regarding the sales performance of the featured product is equal to or higher than the rank determined in advance, and
change a number of the sales performance of the sales product whose rank is output based on the changed rank.

11. The information processing apparatus according to claim 1, wherein
the one or more processors are further configured to execute the instructions to:
output the ranking information to a display device installed in the store.

12. A display system comprising:
an information processing apparatus; and a display device, wherein
the information processing apparatus includes a memory storing instructions; and
one or more processors configured to execute the instructions to:
acquire information indicating a featured product including a product of interest to a customer visiting a store, and
output ranking information, that satisfies a first criterion, regarding a sales performance of the featured product and regarding a parameter; and
the display device is installed in the store and displays the ranking information output.

13. An information processing method comprising:
acquiring information indicating a featured product including a product of interest to a customer visiting a store; and
outputting ranking information, that satisfies a first criterion, regarding a sales performance of the featured product and regarding a parameter.

14. (canceled)
